(19) United States
(12) Patent Application Publication
(10) Pub. No.: US 2023/0159265 A1
(43) Pub. Date: May 25, 2023

(54) WASTE CONTAINER, LINER, AND RAIL SYSTEM

(71) Applicant: INTEGRATED SERVICE PARTNERS IP, LLC, Miami, FL (US)

(72) Inventor: Gustavo LEON, Miami, FL (US)

(21) Appl. No.: 17/917,276

(22) PCT Filed: Apr. 8, 2021
(86) PCT No.: PCT/US2021/026424

§ 371 Date: Oct. 6, 2022

Related U.S. Application Data
(60) Provisional application No. 63/006,751, filed on Apr. 8, 2020.

(51) Int. Cl. B65F 1/00; B65F 1/06; B65F 1/14

(52) U.S. Cl. CPC B65F 1/006; B65F 1/062; B65F 1/1473; B65F 2220/101

(57) ABSTRACT

Disclosed is a waste container, liner, and rail system. The system may include one or more waste containers or one or more basketless systems or liner receivers to direct, hold, and facilitate the sequential replacement of a waste liner. The system may comprise a pull out track system that is adaptable to cabinetry or another defined space for a waste container. The pull out track system may generally include front, rear, side, and/or base panels, as well as at least one internal panel. The at least one internal panel may define an interior space configured to receive waste liners and to dispense the waste liners automatically.

### CROSS-REFERENCE TO RELATED APPLICATIONS

The This application claims priority to Provisional Application No. 63/006,751 filed on Apr. 8, 2020 and entitled “WASTE CONTAINER, LINER, AND RAIL SYSTEM,” which is incorporated herein by reference in its entirety.

### FIELD OF THE INVENTION

The present disclosure relates generally to the field of waste containment and disposal and, more particularly, to an integrated waste container, waste liner, and/or rail system that facilitates the automatic deployment of liners and that is adaptable to fit in cabinetry.

### BACKGROUND

Conventional waste container liners and trash bags generally consist of independent flexible plastic bags that are individually placed into a waste container by a user as needed. While the waste container liners and trash bags may generally contain waste and allow for removal of the filled liner from the container and while the interior of the container may remain reasonably clean, there are, however, several problems with current methods and devices for lining waste containers.

For example, conventional waste container liners are generally provided in separate boxes where a user must locate and retrieve the box, must remove each individual liner from the box on an as-needed basis, must take the separated and retrieved liner from the box and to the waste container, and must ready the liner by inserting the liner through the mouth of the container, cuffing the liner over the rim, repositioning the interior of the liner in the container so it is ready and able to receive waste, and the like. As a result, a significant amount of time and energy may be expended during the process of locating, applying, inserting, and securing the liner into the container. The process is inefficient and includes multiple steps that may be difficult or cumbersome.

Moreover, waste containers are often kept in a cabinet, holder, or hidden space. Waste containers may not be easily accessible or maneuverable. For waste containers that are kept in a cabinet, holder, or hidden space, an additional step of removing the waste container from the cabinet may be required in order to access the container to position the new liner. Additionally, where the conventional waste container is separate from the cabinet or holder, it may be difficult to find a waste container of the appropriate dimensions and size to correspond to the holder, the entire apparatus may be unnecessarily bulky and there may be less space for waste, the waste container may undesirably dislodge from the holder when, as an example, the liner containing waste is pulled, and, like separate liners, the separate waste containers may become misplaced during use or in the household, thus rendering the system unusable until found or replaced.

As a result, there is a need for an automatic and sequentially deployed waste container and liner system that may be integrated into a defined space or cabinetry.

### SUMMARY

The following presents a summary of this disclosure to provide a basic understanding of some aspects. This summary is not intended to identify key or critical elements or define any limitations of embodiments or claims. Furthermore, this summary may provide a simplified overview of some aspects that may be described in greater detail in other portions of this disclosure. It is noted that although some aspects may be described in reference to a particular embodiment, the embodiments are adaptable and the aspects interchangeable so that various combinations of aspects are encompassed broadly by this disclosure.

Disclosed is a waste container, liner, and rail system. The system may include one or more waste containers or one or more basketless systems or liner receivers to direct, hold, and facilitate the sequential replacement of a waste liner. The system may comprise a pull out track system that is adaptable to cabinetry or another defined space for a waste container. The pull out track system may generally include front, rear, side, and/or base panels, as well as at least one internal panel. The at least one internal panel may define an interior space configured to receive waste liners and to dispense the waste liners automatically.

Disclosed is a bucketless waste container and liner system. In an embodiment, the system may comprise a front panel, a rear panel, and two side panels. The two side panels may connect the front panel and the back panel. The front, rear, and side panels may form a housing. In an embodiment, the system may further comprise at least one middle panel. The at least one middle panel may be positioned within the housing and may define a first chamber configured to receive and hold a liner and a second chamber configured to receive a liner packet. In an embodiment, the middle panel may include a feed slot that is configured to allow the feeding of a liner into the first chamber from a liner packet in the second chamber.

In an embodiment, the system may not include a removable waste bucket. In an embodiment, the liner when positioned in the first chamber may be configured to receive waste. In an embodiment, at least one of the front, rear, or side panels may include at least one cut-out. Each of the two side panels may include a plurality of cut-outs. The at least one cut-out may be formed by computer numerical control with diamond tooling, electrical discharge or spark machining, laser, water-jet, sand blasting, sawing, or grinding.

In an embodiment, the liner packet may include a plurality of liners. The liners may be fed sequentially from the liner packet in the second chamber, through the feed slot, and into the first chamber when the used liner in the first chamber is removed. The liners may be fed and replaced automatically from the liner packet in the second chamber, through the feed slot, and into the first chamber when the used liner in the first chamber is removed.

In an embodiment, the system may further include a rail and pull out track system. The system may be configured to be put into a cabinet and the rail and pull out track system may facilitate the selective access to and closure of the system into the cabinet.

In an embodiment, a portion of the side panels that defines the first chamber may be a first height and a portions of the side panels that defines the second chamber may be a second height. The height may refer to the height from a side perspective, e.g. side walls, noting that the first chamber and second chamber may share a wall, e.g. the middle panel, and the middle panel may be the first height. In an embodiment, the second height of the side panels defining the second chamber may be smaller than the first height of the side panels defining the first chamber.

In an embodiment, the system may include a second middle panel. The second middle panel may define a third chamber. The third chamber may be configured to receive and hold a liner. The second middle panel may include a feed slot that is configured to allow the feeding of a liner from a second liner packet into the third chamber from the second liner packet in the second chamber. In an embodiment, a portion of the side panels that defines the first and third chamber may be a first height and a portion of the side panels that defines the second chamber may be a second height. In an embodiment, the second height may be smaller than the first height.

Disclosed is an integrated waste container and liner system. The system may comprise a first chamber configured to receive a liner and a second chamber configured to receive a liner packet. The first chamber and second chamber may be adjacent and separated by a middle panel. The middle panel may comprise a feed slot that is configured to allow the feeding of a liner into the first chamber from a liner packet in the second chamber. In an embodiment, the first chamber may be a first height and the second chamber may be a second height. The height may refer to the height from a side perspective, noting that the first chamber and second chamber may share a wall, e.g. the middle panel, and the middle panel may be the first height. In an embodiment, the second height may be smaller than the first height.

In an embodiment, the system may further include a third chamber configured to receive a liner. The second chamber and third chamber may be adjacent and separated by a second middle panel. The second middle panel may comprise feed slot that is configured to allow the feeding of the liner into the third chamber from a second liner packet in the second chamber. In an embodiment, the third chamber and first chamber may be a first height and the second chamber may be a second height. The height may refer to the height from a side perspective, noting that the first chamber and second chamber may share a wall, e.g. the middle panel, and the second chamber and third chamber may share a wall, e.g. the second middle panel, and the middle panel and second middle panel may be the first height. In an embodiment, the second height may be smaller than the first height.

In an embodiment, the system may not include a removable waste bucket. In an embodiment, the chambers may include a plurality of cut-outs. In an embodiment, the liners may be fed sequentially and automatically from the liner packet in the second chamber, through the feed slot, and into the first chamber when the used liner in the first chamber is removed.

The following description and the drawings disclose various illustrative aspects. Some improvements and novel aspects may be expressly identified, while others may be apparent from the description and drawings.

### BRIEF DESCRIPTION OF THE DRAWINGS

The present teachings may be better understood by reference to the following detailed description taken in connection with the following illustrations, wherein:

FIG. 1 shows an embodiment of a waste management system configured to receive and including two buckets in accordance with various aspects as disclosed herein;

FIGS. 2A-E show components of an embodiment of a waste management system configured to receive two buckets in accordance with various aspects as disclosed herein;

FIG. 3 shows an embodiment of a waste management system configured to receive and including one bucket provided or assembled in a partial cabinet in accordance with various aspects as disclosed herein;

FIGS. 4A-E show components of an embodiment of a waste management system configured to receive one bucket in accordance with various aspects as disclosed herein;

FIGS. 5A-C show embodiments of a waste management system including two liner receivers or basketless systems in accordance with various aspects as disclosed herein;

FIGS. 6A-D show components of an embodiment of a waste management system including two liner receivers or basketless systems in accordance with various aspects as disclosed herein;

FIG. 7 shows an embodiment of a waste management system including one liner receiver or basketless system in accordance with various aspects as disclosed herein;

FIGS. 8A-E show components of an embodiment of a waste management system including one liner receiver or basketless system in accordance with various aspects as disclosed herein;

FIG. 9 shows an embodiment of a waste management system provided or assembled in a cabinet in accordance with various aspects as disclosed herein;

FIG. 10 shows a method of forming components of an embodiment of a waste management system in accordance with various aspects as disclosed herein;

FIGS. 11A-B show embodiments of liners that may be used in a waste management system in accordance with various aspects as disclosed herein;

FIG. 12 shows an embodiment of liners selectively positioned in a component of a waste management system in accordance with various aspects as disclosed herein;

FIG. 13 shows an embodiment of a locking wheel that may be selectively coupled to a waste management system in accordance with various aspects as disclosed herein; and

FIG. 14 shows an embodiment of a tilt that may be selectively coupled to a waste management system in accordance with various aspects as disclosed herein.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. Moreover, features of the various embodiments may be combined or altered without departing from the scope of the present teachings. As such, the following description is presented by way of illustration only and should not limit in any way the various alternatives and modifications that may be made to the illustrated embodiments and that would still be within the spirit and scope of the present teachings. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Further, unless context suggest otherwise, descriptions of shapes (e.g., circular, rectangular, triangular, etc.) and the nature of the shapes (e.g., straight, curved, elevated, sloped, wavy, etc.) refer to shapes meeting the definition of such shapes and general representation of such shapes. For instance, a triangular shape or generally triangular shape may include a shape that has three sides and three vertices or a shape that generally represents a triangle, such as a shape having three major sides that may or may not have straight edges, triangular like shapes with rounded vertices, etc. A panel may have any number of sides, such as four, and may generally adopt the shape of a parallelogram, rectangle, square, or the like. A panel may have any number of cut-outs or may be solid. Although general measurements or indications of height, length, width, and thickness may be disclosed, it is noted that these aspects are broadly defined within this disclosure.

Disclosed is a waste management system. Disclosed is a waste container, liner, and rail system. The system may include one or more waste containers or one or more basketless (or bucketless) systems or liner receivers to direct, hold, and facilitate the sequential replacement of a waste liner. The system may comprise a pull out track system that is adaptable to cabinetry or another defined space for a waste container. The pull out track system may generally include front, rear, side, and/or base panels, as well as at least one internal panel. The at least one internal panel may define an interior space configured to receive waste liners and to dispense the waste liners automatically.

The waste management system may be configured to comprise, receive, or accommodate any number of buckets and/or liners as desired, including 1, 2, 3, 4, 5, etc. buckets or liners. Each bucket receiver or liner receiver may be referred to as a chamber and may be defined by panels or portions of a panel (e.g. front panel, middle panel, and portions of each side panels or middle panel, rear panel, and different portions of each side panels). For examples, the various buckets or liners may be used to organize and categorized different types of waste including compostable materials, medical waste, recyclables like paper, cardboard, plastic, glass, items that are not compostable or recyclable, and the like. The waste management system may generally include a body having a front panel, rear panel, two side panels, and a bottom panel. The body may further include an internal panel to define spaces or chambers for receiving a bucket, open liner, or liner pack. The internal panel may comprise a slot to facilitate the transition of the liner from its pack to an opened position in the bucket or basketless system. It is noted that the term basketless system and liner receiver may be used interchangeably. It is also noted that each the bucket receivers, liner receivers, and liner packet receivers may also be referred to as chambers configured to receive these items. The body may be selectively coupled to a track or rail system, or otherwise inserted into a cabinet, to store and selectively access the waste management system.

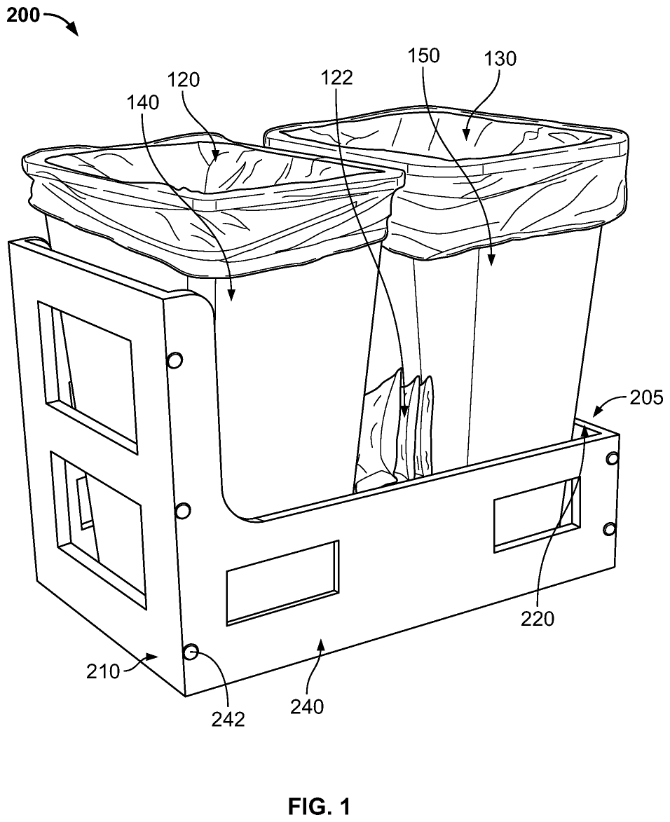

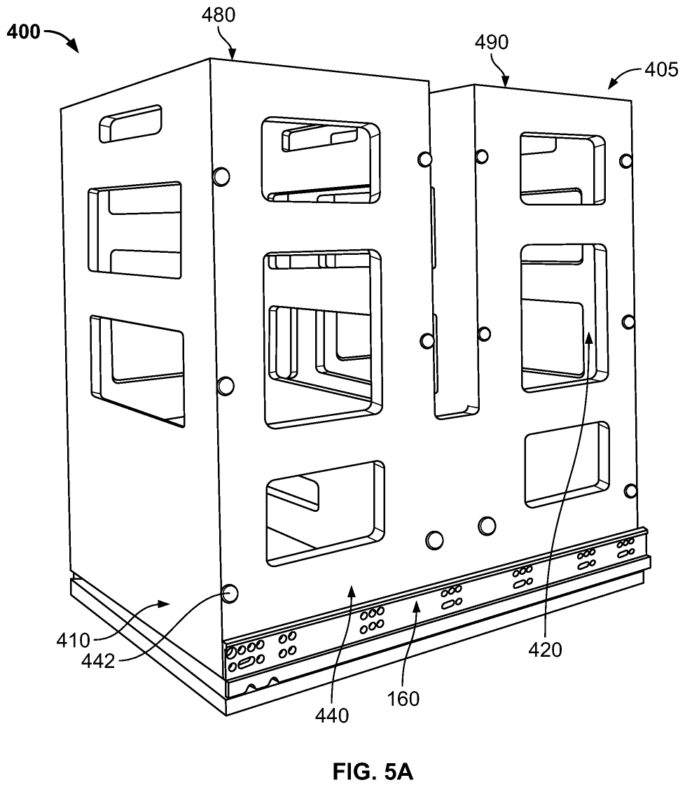

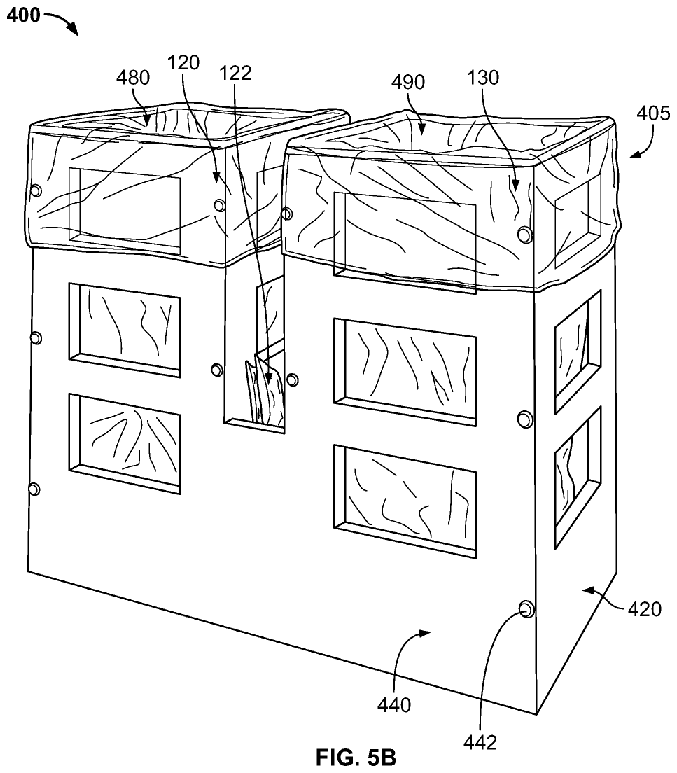

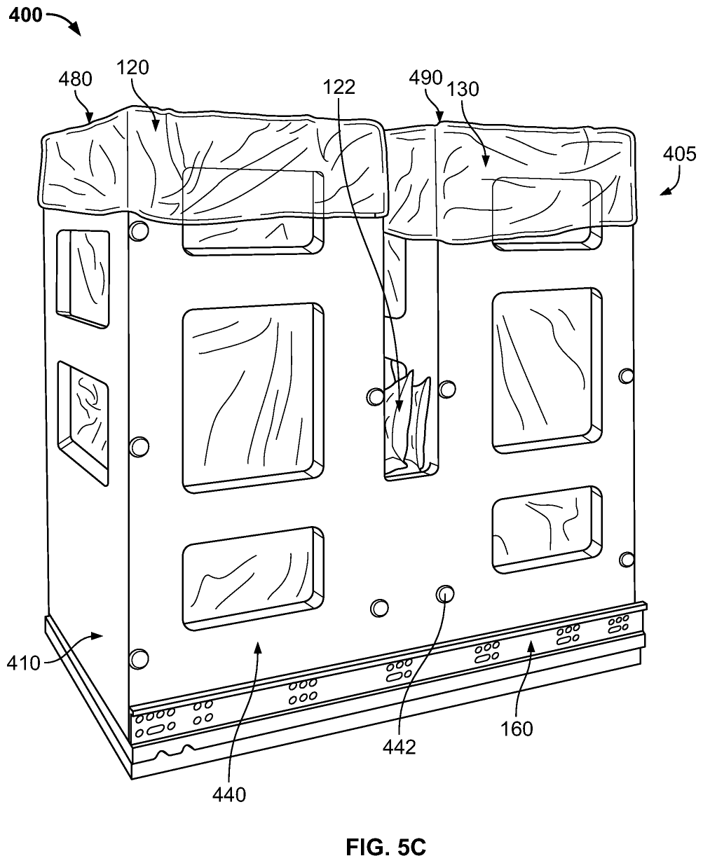

It is noted that any system herein described as including waste buckets and liners may also be provided as a basketless system by integrating and replacing the “panels” of the waste buckets as panels of a basketless system, see FIG. 1 for example compared to FIG. 5A. Alternatively, any system herein described as including waste buckets and liners may also be provided as a basketless system by attaching “buckets” to the panels or framing of a basketless system so that the buckets are not fully detached or floating when positioned in the system. For example, the “buckets” may be attached to the panels or framing of a basketless system by fasteners, friction fit, and the like. It is also noted that the reverse is herein contemplated and that any system herein described as a basketless system may be provided as a system configured to receive waste buckets.

Any system herein described may also be adapted to include any number of buckets, bucket receivers, and liner receivers or basketless systems (e.g., one, two, three, four, five, etc.), including a combination of the different types of waste holders (i.e. buckets, liners only, etc.). In an example, the system may include a removable bucket and a basketless system, a secured bucket and a basketless system, only removable buckets, only secured buckets, only basketless systems or integrated buckets, any combination of the foregoing, and the like.

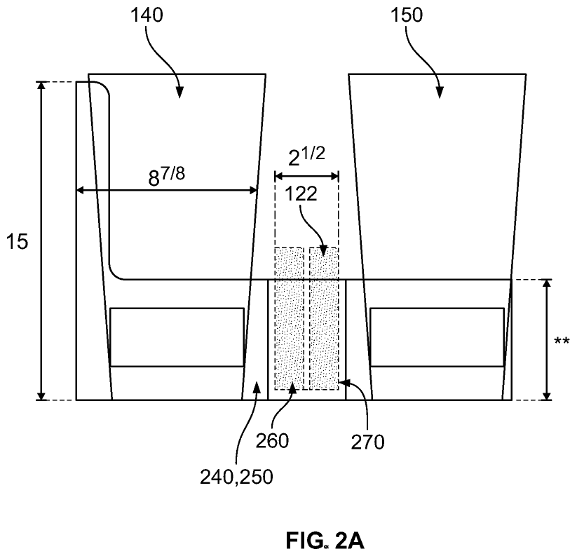

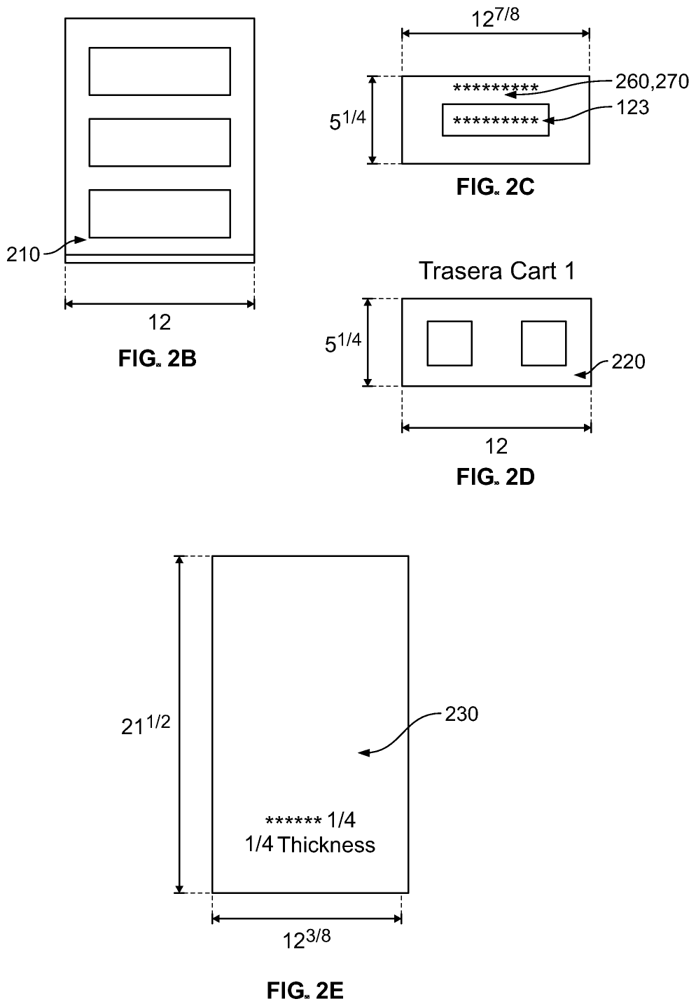

FIG. 1 shows an example of a waste management system 200 configured to selectively receive two buckets 140, 150 and two liners 120, 130, wherein said two buckets 140, 150 are positioned in the waste management system 200 and said two liners 120, 130 are positioned in the buckets 140, 150. Although two buckets are described and shown, the system may be provided to receive or accommodate any number of buckets or liners including a mix of buckets and liners, including, without limitation, one, three, four, five, etc. The waste management system 200 may include a body 205 having a front panel 210, shown in FIG. 2B, a rear panel 220, shown in FIG. 2D, a bottom panel 230, shown in FIG. 2E, and two side panels 240, 250 one of which is shown in FIG. 2A. In an embodiment, the two side panels 240, 250 may be parallel and may attach and connect to parallel front 210 and rear 220 panels in any appropriate manner, including, without limitation through adhesives, friction fit, welding, dove-joints, fasteners or the like or may be monolithically formed. In an embodiment, the bottom panel 230 may attach to and connect to all of the front 210, rear 220, and side panels 240, 250 in any appropriate manner, including, without limitation through adhesives, dove-joints, friction fit, welding, fasteners or the like or may be monolithically formed. In an embodiment, the exterior shape of the body 205 may be rectangular, but the present teachings are not limited to this shape, any appropriate shape may be used. For example, the shape may be generally square, oval or the like. The shape may also taper towards its base or towards its mouth, may include open edges or sides, recessed or protruding edges or sides, and the like. The shape may be irregular and may include contours.

The body 205 of the waste management system 200 may further comprise two middle panels 260, 270, shown in FIG. 2C. In an embodiment, the waste management system 200 may also include one or no middle panels, or any number of middle panels corresponding to the desired number of compartments. The middle panels 260, 270 may insert into an interior space defined by the front 210, rear 220, and side 240, 250 panels. In an embodiment, the middle panels 260, 270 may be parallel to the front 210 and rear 220 panels. In an embodiment, the middle panels 260, 270 may attach (through any means, e.g., fastening, friction fit, welding, adhesives, etc.) to the side panels 240, 250, and the bottom panel 230 or may be monolithically formed. The middle panels 260, 270 may separate the interior space of the body 205 into at least three areas: an area configured to receive the first bucket 140, an area to receive the second bucket 150, and an area to receive the liner packets 122 that feed into each of the buckets 140, 150. An additional panel may also be incorporated to divide and separate each of the liner packets that corresponds and feeds into its respective bucket. The middle panels 260, 270 may include a slot or may allow for space above or below the middle panels 260, 270 when assembled to facilitate the feeding of a liner 120, 130 from the liner packets 122 and into the buckets 140, 150.

The slot or liner passing port slot, when included in the actual middle panel(s) (and not above or below the middle panel) may generally look like slot 123 shown in FIG. 2C. Although not shown in other embodiments, the slot 123 may be provided in any of the embodiments and any of the middle panels, other panels, buckets, etc. disclosed herein. Although shown as generally rectangular, the slot may be circular, ovular, square, irregular, or any other shape as may be desired to accommodate the liners and facilitate the sequential and automatic feeding of the liners from the liner packet, through the slot of the middle panels, and into the liner receiver. Additionally, although shown as generally in the middle or towards the bottom of the middle panel and extending across the majority of the face of the middle panel, it is noted that other orientations are also contemplated. For example, the slot may be half the size or less of the middle panel, may be more vertically oriented instead of the horizontal orientation as shown, may be closer to the top of the middle panel or directly in the middle of the middle panel, etc. Overall, the slot must be able to facilitate the sequential and automatic feeding of the liners from the liner packet, through the slot of the middle panels, and into the liner receiver without breaking the perforations or connection between subsequent liners.

In an embodiment, middle panel(s) 260, 270 may form an area defined as the liner/bag dispenser or liner package housing chamber 122. The housing chamber 122 and a liner passing port slot within each middle panel 260, 270 may facilitate the automatic feeding of sequential liners from liner package(s) positioned in the housing chamber 122, through the liner passing port slot, and into the cavity or body of the buckets 140, 150. Automatic is defined as the continued feeding and access of liners in a sequential sequence or individual form when, for example, the first liner in the sequence is pulled or removed through the bucket (e.g. when it is full with waste and a new liner is desired). The liner passing port slot may be located at the bottom of each middle panel 260, 270.

Liner package(s) may have an indicator marked on its outer packaging to facilitate opening of the package, exposing and accessing the liners, and where to align or line up the liners with the liner passing port slot located in the housing chamber 122. The first liner may be pulled out half way in order to feed it through the liner passing port slot, from the housing chamber 122 and into the body of the bucket 140, 150. The liner may be pulled up and positioned in the body of the bucket 140,150. The liner may be opened and fit or secured about the top rim or circumference of the bucket 140, 150.

After the liner is filled, the liner may be cinch closed with a closure tab provided at the top edge of the liner(s), or if no tab is provided or desired, the liner may be folded over the top rim or circumference of the bucket. The liner may be pulled up and sequential liner that is thereby removably connected (e.g. by perforation) in sequence will rise up through the liner passing port slot. The liners may be detached and the process repeated. In some embodiments, the liners may be attached end-to-end such that as the first liner is pulled out to be used it is detached from the next sequential liner (e.g., the adjacent liners may have perforations to remove the first adjacent one from the second adjacent one.) It is noted that the buckets 140, 150 may further include a slot that aligns with the liner passing port slot or the slots of the any middle panels so that the liners can be fed from the liner package, through the middle panel or other panels if applicable, through the bucket or basketless system, including any panels that form the holder for the bucket or panels of the basketless system, and into the interior of the bucket or basketless system where it is opened and positioned to receive waste therein, while remaining attached to the sequential liners below.

The height and shape of the front 210, rear 220, and side panels 240, 250 may be adjusted as desired. For example, as shown in FIGS. 1 and 2A-E, in an embodiment the front panel 210 may have a height at, near, or just under the height of the buckets 140, 150. The rear panel 220, on the other hand, in an embodiment, may be lower, at a point at about a third of the height of the buckets 140, 150. The side panels 240, 250, then, may slope both to meet the height of the front panel 210 at the point of attachment between the two panels and to meet the height of the rear panel 220 at the point of attachment between the two panels. The middle panels 260, 270 may be about the same height or lower than the rear panel 220 or the side panels 240, 250 at the point of attachment between the side panels 240, 250 and the middle panels 260, 270. The slope of the side panels 240, 250 may be any varying gradient, such as a consistent slope forming a diagonal equally across the side of the waste management system 200, or the slope may be more sharp, as is shown the FIGS. 1 and 2A-E where the majority of the side panels 240, 250 are the height of the rear panel 220. In this embodiment, the lower height of the side panels 240, 250 may allow for easy access to the liner packets 122, as well as allow for the insertion and removal of the buckets 140, 150 from a lower height (e.g. only having to lift enough to overcome the lower height of the side panel rather than a high height of the cabinet). Additionally, the lower height may allow for the accommodation of variously shaped buckets including buckets that may taper or flare toward to the top or the mouth.

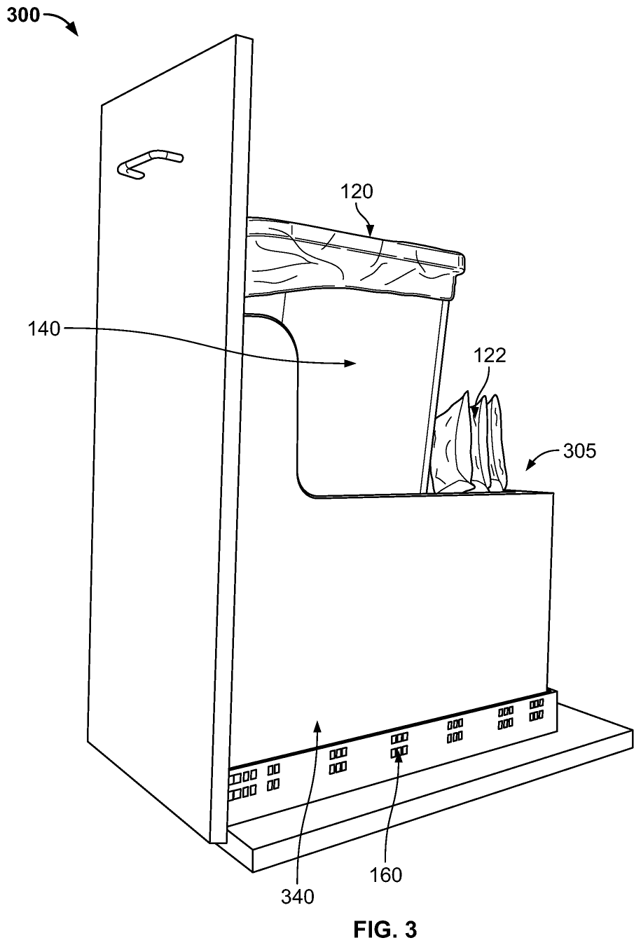

The waste management system 200 (or any of the waste management systems as described herein) may further comprise a rail or track 160, see FIG. 3 for example, and may be inserted into a cabinet for storage of the waste management system 200, see FIG. 9 for example. In an embodiment, the rail or track 160 may be similar or the same as a rail or track for a drawer. The rail or track 160 may be full extension as to allow selective full access to the waste management system 200 when opened. Further, the rail or track 160 may include a slow-close feature similar to what a cabinet may have. That is, one the user pushes the waste management system 200 to close; it will slowly close to prevent the waste management system 200 from slamming closed.

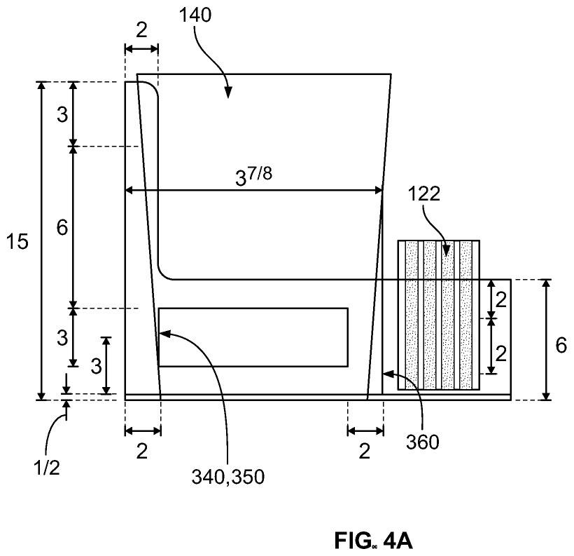

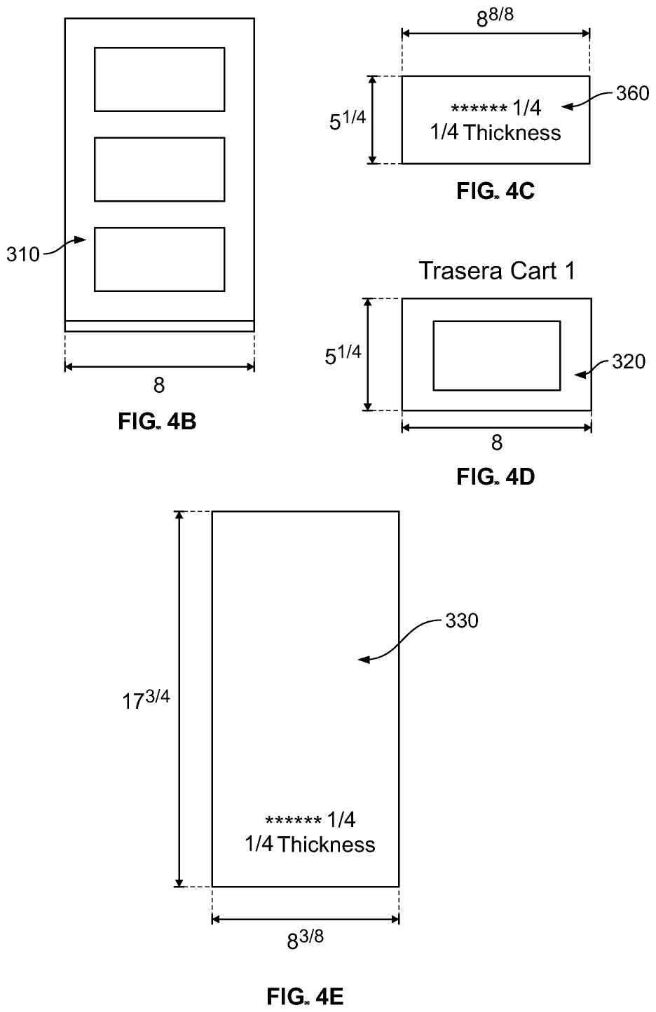

FIG. 3 shows an example of a waste management system 300 configured to selectively receive at least one bucket 140 and one liner 120 wherein said one bucket 140 is positioned in the waste management system 200 and said one liner 120 is positioned in the bucket 140. Although one bucket is described and shown, the system may be provided to receive or accommodate any number of buckets or liners including a mix of buckets and liners. In the embodiment shown, the waste management system 300 may comprise a door that generally matches the door of the cabinets into which the waste management system 300 is installed. The door can be of any appropriate configuration and is not limited to what is shown. The waste management system 300 may include a body 305 having a front panel 310, shown in FIG. 4B, a rear panel 320, shown in FIG. 4D, a bottom panel 330, shown in FIG. 4E, and two side panels 340, 350 one of which is shown in FIG. 4A. In an embodiment, the two side panels 340, 350 may be parallel and may attach and connect to parallel front 310 and rear 320 panels in any appropriate manner, including, without limitation through adhesives, dove-joints, fasteners, friction fit, welded or the like or may be monolithically formed. In an embodiment, the bottom panel 330 may attach to and connect to all of the front 310, rear 320, and side panels 340, 350 in any appropriate manner, including, without limitation through adhesives, dove-joints, fasteners, friction fit, welded or the like or may be monolithically formed. In an embodiment, the exterior shape of the body 305 may be rectangular.

The body 305 of the waste management system 300 may further comprise at least one middle panel 360, shown in FIG. 4C. In an embodiment, the waste management system 300 may also include more (two, three or four) or no middle panels, or any number of middle panels corresponding to the desired number of compartments. The middle panel 360 may insert into an interior space defined by the front 310, rear 320, and side 340, 350 panels. In an embodiment, the middle panel 360 may be parallel to the front 310 and rear 320 panels. In an embodiment, the middle panel 360 may attach to the side panels 340, 350, and the bottom panel 330. The middle panel 360 may separate the interior space of the body 305 into at least two areas: an area configured to receive the bucket 140 and an area to receive the liner packets 122 that feed into the bucket 140. The middle panel 360 may include a slot or may allow for space above or below the middle panel 36 when assembled to facilitate the feeding of a liner 120 from the liner packets 122 and into the bucket 140.

In an embodiment, middle panel 360 may form an area defined as the liner/bag dispenser or liner package housing chamber 122. The housing chamber 122 and a liner passing port slot within the middle panel 360 may facilitate the automatic feeding of sequential liners from liner package(s) positioned in the housing chamber 122, through the liner passing port slot, and into the cavity or body of the bucket 140. Automatic is defined as the continued feeding and access of liners in a sequential sequence or individual form. The liner passing port slot may be located at the bottom of the middle panel 360.

Liner package(s) may have an indicator marked on its outer packaging to facilitate opening of the package, exposing and accessing the liners, and where to align or line up the liners with the liner passing port slot located in the housing chamber 122. The first liner may be pulled out half way in order to feed it through the liner passing port slot, from the housing chamber 122 and into the body of the bucket 140. The liner may be pulled up and positioned in the body of the bucket 140. The liner may be opened and fit or secured about the top rim or circumference of the bucket 140.

After the liner is filled, the liner may be cinch closed with a closure tab provided at the top edge of the liner(s), or if no tab is provided or desired, the liner may be folded over the top rim or circumference of the bucket. The liner may be pulled up and sequential liner that is thereby removably connected (e.g. by perforation) in sequence will rise up through the liner passing port slot. The liners may be detached and the process repeated. In some embodiments, the liners may be attached end-to-end such that as the first liner is pulled out to be used it is detached from the next sequential liner (e.g., the adjacent liners may have perforations to remove the first adjacent one from the second adjacent one.) It is noted that the bucket 140 may further include a slot that aligns with the liner passing port slot or the slots of any middle panels so that the liners can be fed from the liner package, through the middle panel or other panels if applicable, through the bucket or basketless system, including any panels that form the holder for the bucket or panels of the basketless system, and into the interior of the bucket or basketless system where it is opened and positioned to receive waste therein, while remaining attached to the sequential liners below.

The height and shape of the front 310, rear 320, and side panels 340, 350 may be adjusted as desired. For example, as shown in FIGS. 3 and 4A-E, in an embodiment the front panel 310 may have a height at, near, or just under the height of the buckets 140, 150. The rear panel 320, on the other hand, in an embodiment, may be lower, at a point at about a third of half of the height of the buckets 140, 150. The side panels 340, 350, then, may slope both to meet the height of the front panel 310 at the point of attachment between the two panels and to meet the height of the rear panel 320 at the point of attachment between the two panels. The middle panel 360 may be about the same height or lower than the rear panel 320 or the side panels 340, 350 at the point of attachment between the side panels 340, 350 and the middle panels 360, 370. The slope of the side panels 340, 350 may be any varying gradient, such as a consistent slope forming a diagonal equally across the side of the waste management system 300, or the slope may be more sharp, as is shown the FIGS. 3 and 4A-E where the majority of the side panels 340, 350 are the height of the rear panel 320. In this embodiment, the lower height of the side panels 340, 350 may allow for easy access to the liner packets 122, as well as allow for the insertion and removal of the bucket 140 from at a lower height (e.g. only having to lift enough to overcome the lower height of the side panel rather than a high height of the cabinet). Additionally, the lower height may allow for the accommodation of variously shaped buckets including buckets that may taper or flare toward to the top or the mouth.

The waste management system 300 (or any of the waste management systems as described herein) may further comprise a rail or track 160, see FIG. 3 for example, and may be inserted into a cabinet for storage of the waste management system 300, see FIG. 9 for example. In am embodiment, the rail or track 160 may be similar or the same as a rail or track for a drawer. The rail or track 160 may be full extension as to allow selective full access to the waste management system 300 when opened.

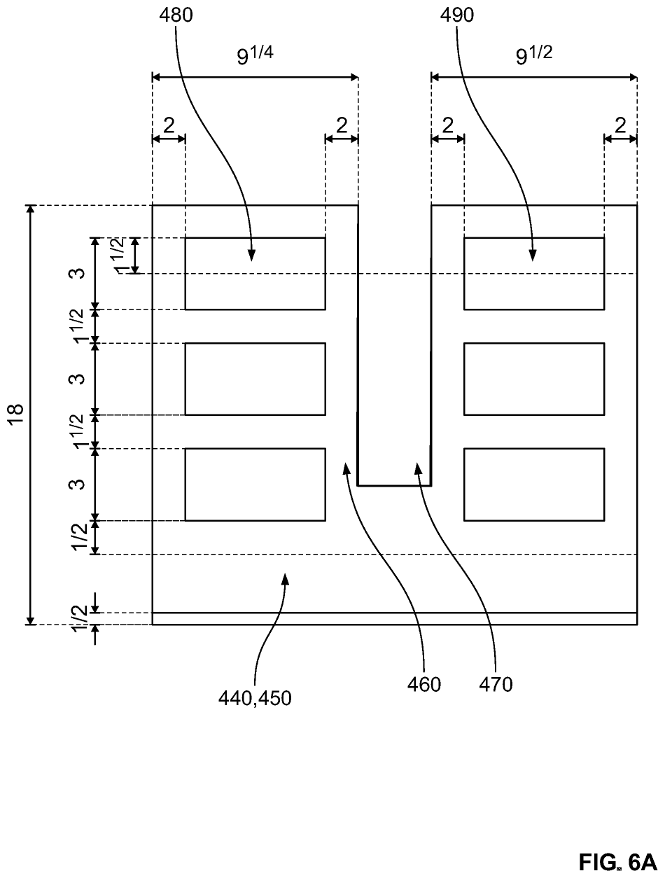

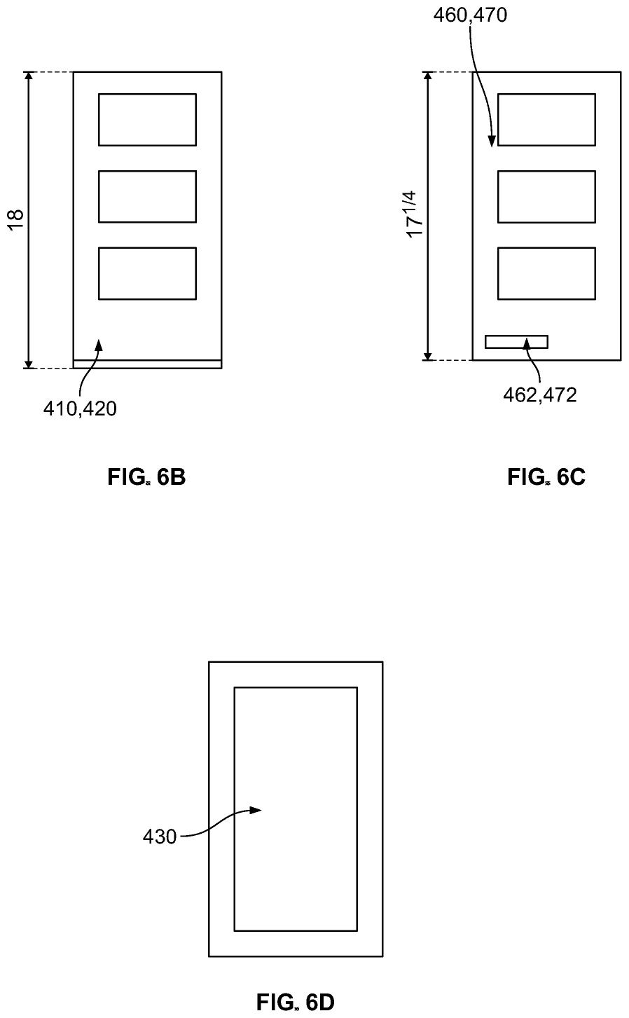

FIGS. 5A-C show an example of a waste management system 400 configured to selectively receive two liners 120, 130 in two basketless systems or liner receivers 480, 490. FIGS. 5B-C show the liners 120, 130 positioned in the basketless systems 480, 490. Although two basketless systems or liner receivers are described and shown, the system may be provided to receive or accommodate any number of buckets or liners including a mix of buckets and liners (e.g., one, two, three, four, five, six or more). The waste management system 400 may include a body 405 having a front panel 410 and a rear panel 420, shown in FIG. 6B, a bottom panel 430, shown in FIG. 6D, and two side panels 440, 450 one of which is shown in FIG. 6A. In an embodiment, the two side panels 440, 450 may be parallel and may attach and connect to parallel front 410 and rear 420 panels in any appropriate manner, including, without limitation through adhesives, dove-joints, fasteners, friction fit, welded or the like or may be monolithically formed. In an embodiment, the bottom panel 430 may attach to and connect to all of the front 410, rear 420, and side panels 440, 450 in any appropriate manner, including, without limitation through adhesives, friction fit, welded, dove-joints, fasteners or the like or may be monolithically formed. In an embodiment, the exterior shape of the body 405 may be rectangular.

The body 405 of the waste management system 400 may further comprise two middle panels 460, 470, shown in FIG. 6C. In an embodiment, the waste management system 400 may also include one or no middle panels, or any number of middle panels (e.g., two, three, four, five or more) corresponding to the desired number of compartments. The middle panels 460, 470 may insert into an interior space defined by the front 410, rear 420, and side 440, 450 panels. In an embodiment, the middle panels 460, 470 may be generally parallel (i.e., within 1 to 10 degrees of parallel) to the front 410 and rear 420 panels. In an embodiment, the middle panels 460, 470 may attach to the side panels 440, 450, and the bottom panel 430 in any appropriate manner, including, without limitation through adhesives, friction fit, welded dove-joints, fasteners or the like or may be monolithically formed. The middle panels 460, 470 may separate the interior space of the body 405 into at least three areas: a first basketless system 480 configured to receive the first liner 120, a second basketless system 490 configured to receive the second liner 130, and an area to receive the liner packets 122 that feed into each of the basketless systems 480, 490. An additional panel may also be incorporated to divide and separate each of the liner packets that corresponds and feeds into its respective basketless system. The middle panels 460, 470 may include a slot 462, 472 or may allow for space above or below the middle panels 460, 470 when assembled to facilitate the feeding of a liner 120, 130 from the liner packets 122 and into the basketless systems 480, 490.

In an embodiment, middle panel(s) 460, 470 may form an area defined as the liner/bag dispenser or liner package housing chamber 122. The housing chamber 122 and a liner passing port slot within each middle panel 460, 470 may facilitate the automatic feeding of sequential liners from liner package(s) positioned in the housing chamber 122, through the liner passing port slot, and into the cavity or body of the basketless systems 480, 490. Automatic is defined as the continued feeding and access of liners in a sequential sequence or individual form. The liner passing port slot may be located at the bottom of each middle panel 460, 470.

Liner package(s) may have an indicator marked on its outer packaging to facilitate opening of the package, exposing and accessing the liners, and where to align or line up the liners with the liner passing port slot located in the housing chamber 122. The first liner may be pulled out half way in order to feed it through the liner passing port slot, from the housing chamber 122 and into the body of the basketless system 480, 490. The liner may be pulled up and positioned in the body of the basketless system 480, 490. The liner may be opened and fit or secured about the top rim or circumference of basketless system 480, 490.

After the liner is filled, the liner may be cinch closed with a closure tab provided at the top edge of the liner(s), or if no tab is provided or desired, the liner may be folded over the top rim or circumference of the bucket. The liner may be pulled up and sequential liner that is thereby removably connected (e.g. by perforation) in sequence will rise up through the liner passing port slot. The liners may be detached and the process repeated. In some embodiments, the liners may be attached end-to-end such that as the first liner is pulled out to be used it is detached from the next sequential liner (e.g., the adjacent liners may have perforations to remove the first adjacent one from the second adjacent one.) It is noted that the system may include other slots as needed that align with the liner passing port slot or the slots of any middle panels so that the liners can be fed from the liner package, through the middle panel or other panels if applicable, through the bucket or basketless system, including any panels that form the holder for the bucket or panels of the basketless system, and into the interior of the bucket or basketless system where it is opened and positioned to receive waste therein, while remaining attached to the sequential liners below.

The height and shape of the front 410, rear 420, and side panels 440, 450 may be adjusted as desired. For example, as shown in FIGS. 5A-C and 6A-D, in an embodiment the front panel 410, rear panel 420, and middle panels 460, 470 may have substantially the same height wherein the height is about the height desired for a waste container, such as a bucket 140, 150. The side panels 440, 450, then, may be substantially the same height as the front panel 410 at the point of attachment between the two panels and may be substantially the same as the height of the rear panel 420 at the point of attachment between the two panels. With the front panel 410, rear panel 420, middle panels 460, 470, and portions of the side panels 440, 450 being the same height, these may form the basketless systems 480, 490 which may, in turn, serve a similar function as buckets 140, 150 but without requiring the separate element of a bucket 140, 150. The side panels 440, 450 may be about the same height all across or the side panels 440, 450 may have a different height. In an embodiment, as is shown the FIGS. 5A-C and 6A-D, a portion of the side panels 440, 450 may be lower to receive the liner packets 122. In this embodiment, the lower height of the side panels 240, 250 may allow for easy access to the liner packets 122. The liner packets 122 may be located between the two basketless systems 480, 490. In some embodiments, the basketless systems 480, 490 may be configured such that one of the basketless system portions 480 or 490 may be of a different shape and size than the other of the basketless system portions 480 or 490. This may allow a user to use one of the basketless system portions 480 or 490 as a recycling bin and the other of the basketless system portions 480 or 490 as a garbage bin. Alternatively, instead or in addition to being of a different size, one of the basketless system portions 480 or 490 may be a different shape or configuration where one shape or configuration is recycling and the other is for garbage. Further still, while a recycling bin and garbage bin are discussed, the basketless systems 480, 490 can either or both be used as a storage container.

In the embodiments shown, the panels may include cut-outs, holes or apertures of any appropriate configuration. The cut-outs, holes or apertures may be of any appropriate shape and configurations. The cut-outs, holes or apertures may be formed after the formation of a panel from a sheet material or may be formed as the panel is formed as during injection molding, for example. The cut-outs, holes or apertures may reduce the weight of the panels and reduce the amount of material required to produce the panels while maintaining the panels' strength and integrity, may streamline production, may reduce costs in material and transport, and the like. The panels may be made of any appropriate material, including, without limitation plastic, rubber, wood, composite materials such as medium density fiberboard or particle board, metal, or a combination of the foregoing. The material may be stiff enough to maintain its shape and rigidity to accept a bag as described herein.

The waste management system 400 (or any of the waste management systems as described herein) may further comprise a rail or track 160, see FIG. 5A and 5C for example, and may be inserted into a cabinet for storage of the waste management system 400, see FIG. 9 for example. In am embodiment, the rail or track 160 may be similar or the same as a rail or track for a drawer. The rail or track 160 may be full extension as to allow selective full access to the waste management system 400 when opened. Further still the rail or track 160 may comprise a slow-close configuration.

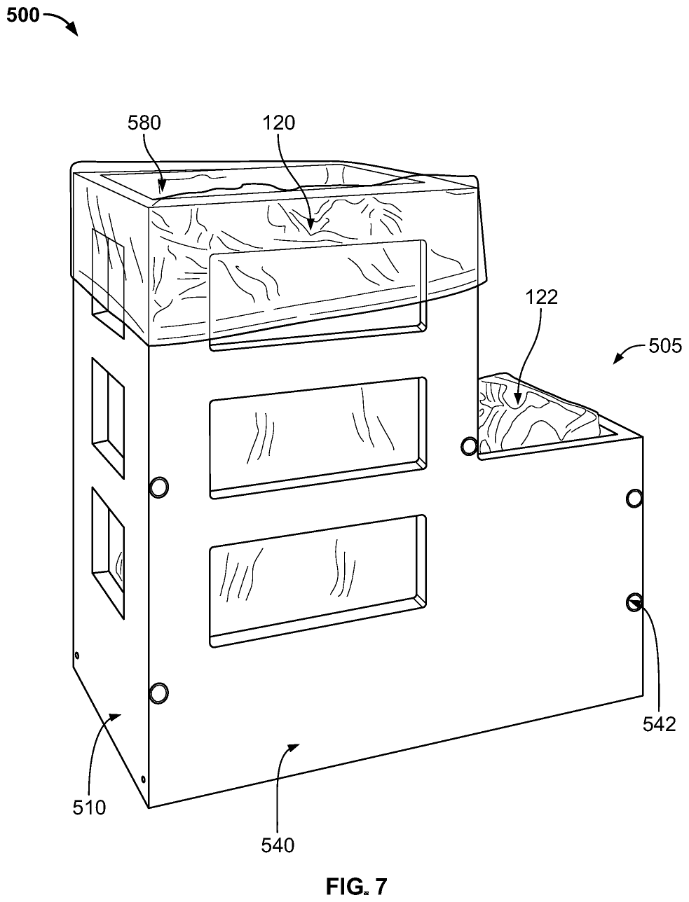

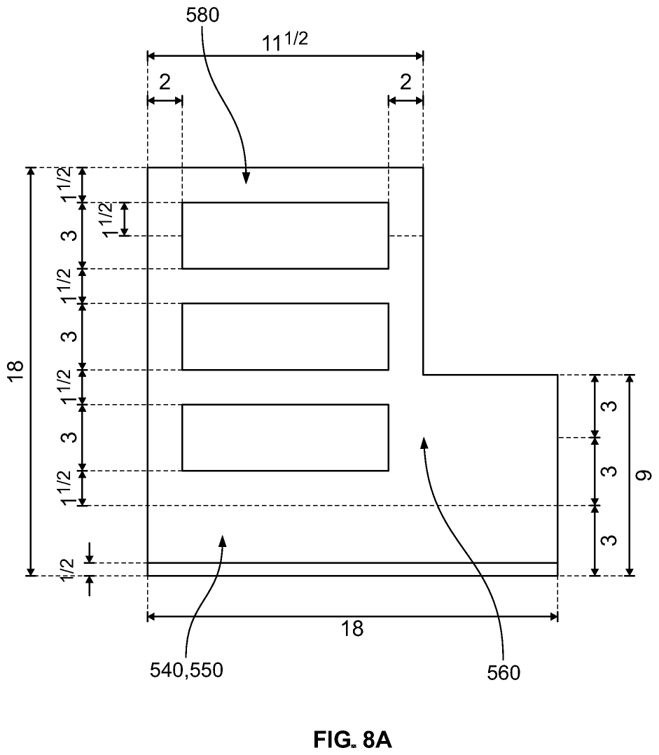

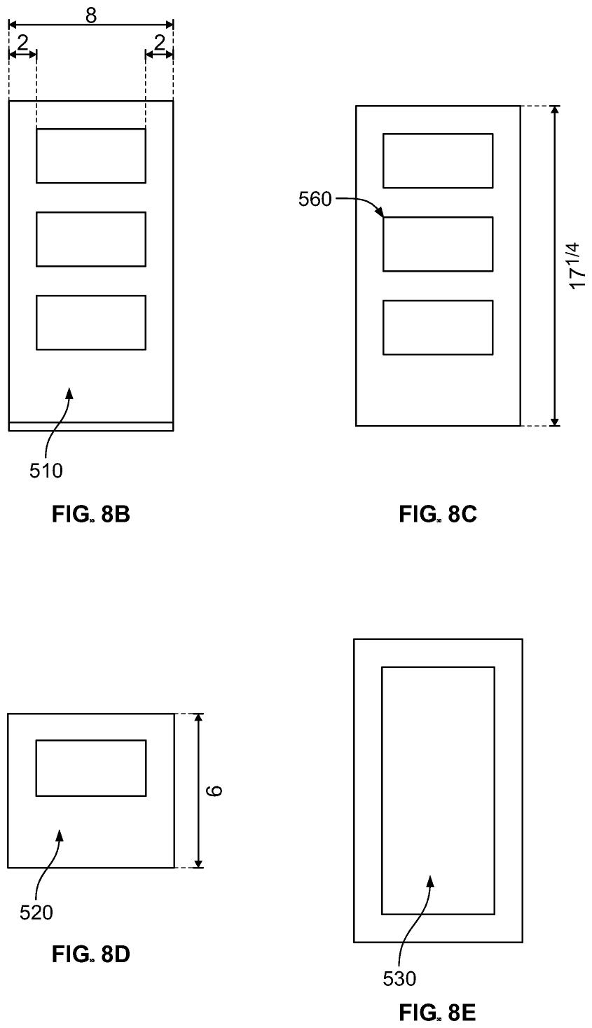

FIG. 7 shows an example of a waste management system 500 configured to selectively receive at least one liner 120 in at least one basketless system 580 wherein said one liner 120 is positioned in the basketless system 580. Although one basketless system 580 or liner receiver is described and shown, the system may be provided to receive or accommodate any number of buckets or liners including a mix of buckets and liners (e.g., one, two, three, four, five, etc.). The waste management system 500 may include a body 505 having a front panel 510, shown in FIG. 8B, a rear panel 520, shown in FIG. 8D, a bottom panel 530, shown in FIG. 8E, and two side panels 540, 550 one of which is shown in FIG. 8A. In an embodiment, the two side panels 540, 550 may be parallel and may attach and connect to parallel front 510 and rear 520 panels in any appropriate manner, including, without limitation through adhesives, dove-joints, fasteners or the like. In an embodiment, the bottom panel 530 may attach to and connect to all of the front 510, rear 520, and side panels 540, 550 or may be monolithically formed. In an embodiment, the exterior shape of the body 505 may be rectangular.

The body 505 of the waste management system 500 may further comprise at least one middle panel 560, shown in FIG. 8C. In an embodiment, the waste management system 500 may also include more or no middle panels, or any number of middle panels corresponding to the desired number of compartments (e.g., one, two, three, four, five or more). The middle panel 560 may insert into an interior space defined by the front 510, rear 520, and side 540, 550 panels. In an embodiment, the middle panel 560 may be parallel to the front 510 and rear 520 panels. In an embodiment, the middle panel 560 may attach to the side panels 540, 550, and the bottom panel 530. The middle panel 560 may separate the interior space of the body 505 into at least two areas: a basketless system 580 configured to receive the liner 120 and an area to receive the liner packets 122 that feed into the basketless system 580. The middle panel 560 may include a slot 562 or may allow for space above or below the middle panel 560 when assembled to facilitate the feeding of a liner 120 from the liner packets 122 and into the basketless system 580.

In an embodiment, middle panel 560 may form an area defined as the liner/bag dispenser or liner package housing chamber 122. The housing chamber 122 and a liner passing port slot within the middle panel 560 may facilitate the automatic feeding of sequential liners from liner package(s) positioned in the housing chamber 122, through the liner passing port slot, and into the cavity or body of the basketless system 580. Automatic is defined as the continued feeding and access of liners in a sequential sequence or individual form. The liner passing port slot may be located at the bottom of the middle panel 560.

Liner package(s) may have an indicator marked on its outer packaging to facilitate opening of the package, exposing and accessing the liners, and where to align or line up the liners with the liner passing port slot located in the housing chamber 122. The first liner may be pulled out half way in order to feed it through the liner passing port slot, from the housing chamber 122 and into the body of the basketless system 580. The liner may be pulled up and positioned in the body of the basketless system 580. The liner may be opened and fit or secured about the top rim or circumference of basketless system 580.

After the liner is filled, the liner may be cinch closed with a closure tab provided at the top edge of the liner(s), or if no tab is provided or desired, the liner may be folded over the top rim or circumference of the bucket. The liner may be pulled up and sequential liner that is thereby removably connected (e.g. by perforation) in sequence will rise up through the liner passing port slot. The liners may be detached and the process repeated. In some embodiments, the liners may be attached end-to-end such that as the first liner is pulled out to be used it is detached from the next sequential liner (e.g., the adjacent liners may have perforations to remove the first adjacent one from the second adjacent one.) It is noted that the system may include other slots as needed that align with the liner passing port slot or the slots of any middle panels so that the liners can be fed from the liner package, through the middle panel or other panels if applicable, through the bucket or basketless system, including any panels that form the holder for the bucket or panels of the basketless system, and into the interior of the bucket or basketless system where it is opened and positioned to receive waste therein, while remaining attached to the sequential liners below.

The height and shape of the front 510, rear 520, and side panels 540, 550 may be adjusted as desired. For example, as shown in FIGS. 7 and 8A-E, in an embodiment the front panel 510 and middle panel 560 may have substantially the same height wherein the height is about the height desired for a waste container, such as a bucket 140, 150. The rear panel 520 on the other hand, in an embodiment, may be lower, at a point at about a third of half of the height of the front 510 and middle panel 560. The side panels 540, 550, then, may be substantially the same height as the front panel 510 at the point of attachment between the two panels and may be substantially the same as the height of the rear panel 520 at the point of attachment between the two panels. With the front panel 510, middle panel 560 and portions of the side panels 540, 550 being the same height, these may form the basketless system 580 which may, in turn, serve a similar function as bucket 140 but without requiring the separate element of a bucket 140. The slope of the side panels 540, 550 between the point of attachment to the higher front and middle 510, 560 panels and the point of attachment to the lower rear side 520 may be any varying gradient, such as a consistent slope forming a diagonal equally across the side of the waste management system 500, or the slope may be more sharp, as is shown the FIGS. 7 and 8A-E where the portion of the side panels 540, 550 between the front and middle 510, 560 panels is substantially the same height as those panels and where the portion of the side panels 540, 550 between the middle and rear 560, 520 panels is substantially the same height as the rear panel 520. In this embodiment, the lower height of the side panels 540, 550 may allow for easy access to the liner packets 122.

In an embodiment, the waste management system 500 (or any of the waste management systems as described herein) may further comprise a rail or track 160, see FIG. 5A and 5C for example, and may be inserted into a cabinet for storage of the waste management system 500, see FIG. 9 for example. In an embodiment, the rail or track 160 may be similar or the same as a rail or track used for a drawer. The rail or track 160 may be full extension as to allow selective full access to the waste management system 500 when opened. The rail or track system 160 may be used for domestic and commercial purposes and the size and shape of the waste management system and baskets or basketless systems may be modified for the particular application and anticipated waste loads and types. The present system may be particularly useful as a medical waste system.

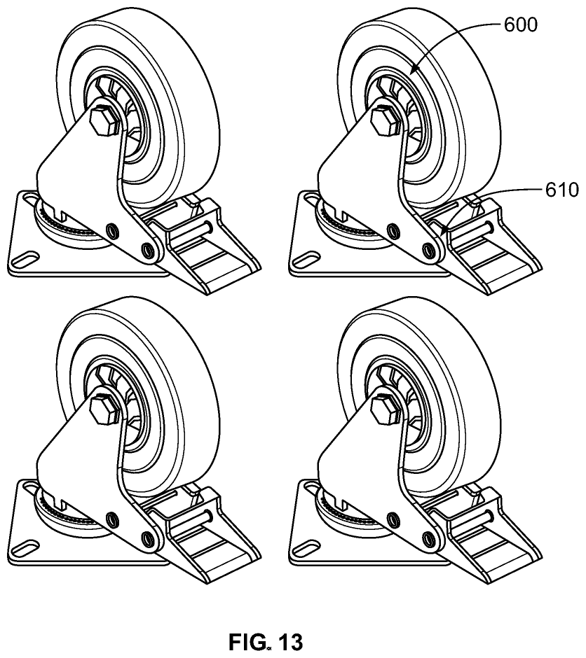

In an embodiment, the waste management system 500 (or any of the other embodiments of the waste management system described above) may optionally comprise one or more wheels 600. An embodiment of the wheels 600 is shown in FIG. 13. The wheels 600 may facilitate flexibility and transport of the waste management system 500 and may be used in lieu of the tracks and drawer system for an independent and freestanding system (or may be used in conjunction therewith). For example, the waste management system 500 may include four wheels 600. The waste management system 500 may include 2, 3, 4, 5, 6, etc. wheels 600. The wheels 600 may be positioned on the bottom panel of any of the described embodiments. In an example, the wheels 600 may be positioned on the bottom panel, near the sides of the bottom panel, in any of the described embodiments. For example, four wheels may be positioned by each of the four corners on the exterior side or outwardly facing side of the bottom panel of any of the described embodiments. In an embodiment, the wheels 600 may also be used instead of or as a replacement to track 160 so that a corresponding track on the drawer or cabinet (or holder) that may otherwise be needed to attach to track 160 and facilitate opening and closing of the drawer or cabinet (or holder) and facilitate selective access to the system is no longer needed. Instead, the wheels 600 may facilitate opening and closing of the cabinet face (or holder) or otherwise facilitate selective access to the system.

In an embodiment, the wheel 600 may include a locking or braking mechanism 610. When engaged the locking or braking mechanism 610 may prevent further rotation of the wheels and otherwise keep the waste management system 500 in the same position. The locking or braking mechanism 610 may be actuated by a force, for example, such as pressing down by a user's foot. The locking or braking mechanism 610 may also be actuated by any other mechanical or electrical mechanism. The wheels 600 may be used for domestic and commercial purposes and the size and shape of the waste management system and baskets or basketless systems may be modified for the particular application and anticipated waste loads and types. In some embodiments, the wheels 600 may be used with the tracks and drawer systems described herein. In these embodiments, the waste management system 500 may be removed from the track system (such as that described above) to facilitate relocating the waste management system 500 such as to remove the waste therefrom. In one embodiment, the waste management system 500 may include a track (such as the ones described above) onto which the wheels 600 can operatively engage such that the waste management system 500 may be rolled out from the drawer system to be positioned in a different location.

Additionally, the wheels 600 may be used for a variety of other purposes and attached to different portions of the system or components of the system. For example, the wheels 600 may be attached to a bucket that is inserted into a bucket receiver to allow the bucket to be wheeled around within the system (and locked in a particular position if desired). The system may also include a ramp so that the wheeled bucket may be wheeled into the bucket receiver and system instead of needing to be picked up and set down into bucket receiver and the system. In an embodiment, the front panel side panel, portion of the side panel, and/or cabinet face may be hinged and selectively opened on the hinge to facilitate the removal of the bucket (which may be made easier by wheels 600 on the bucket).

The track may include an extension that may engage the wheels such that the user may push or pull the waste management system 500 from the drawer system. The extension may slide, rotate, pivot, etc. from the main track to provide a ramp surface that can engage the wheels 600 to roll the waste management system 500 from the drawer system in which it is positioned. The extension may then be folded back to its storage position such that it does not interfere with operation of the waste management system 500 in the drawer system and is hidden from view. Once the extension is needed to help roll the waste management system 500 from its position, it may be folded from its storage position to an operative position in any appropriate manner.

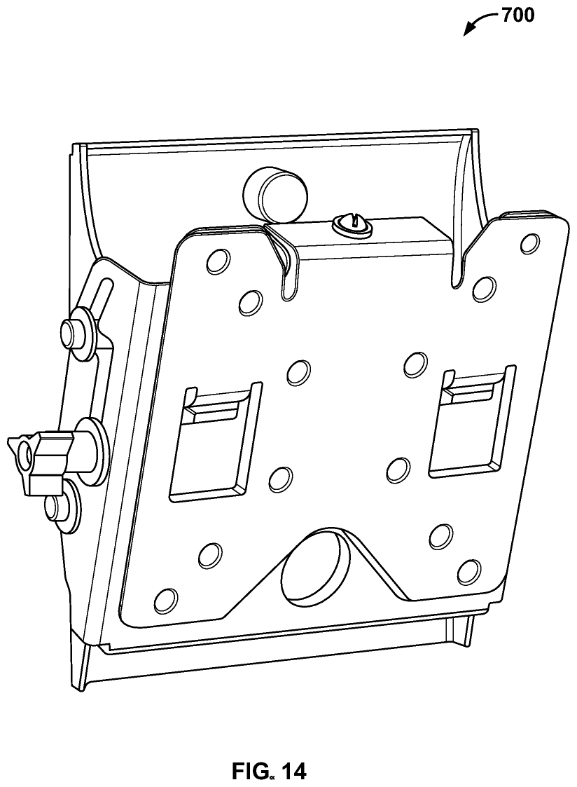

In an embodiment, the waste management system 500 may optionally comprise one or more of a tilt mechanism 700 that may include a stabilizer. An embodiment of the tilt mechanism 700 and stabilizer is shown in FIG. 14. The tilt mechanism 700 and stabilizer may serve as a counterweight to prevent tipping of the waste management system 500 when it is empty, near empty, holding light waste, quickly transported or moved, or when the liner is removed and replaced, and the like. For example, the tilt mechanism 700 and stabilizer may prevent the waste management system 500 from flipping upon taking out a heavy liner. The tilt mechanism 700 and stabilizer may be used for tall or large capacity buckets or liners to facilitate pulling out heavy and maxed weighted liners. The tilt mechanisms 700 may be used for domestic and commercial purposes and the size and shape of the waste management system and baskets or basketless systems may be modified for the particular application and anticipated waste loads and types.

Further, the tilt mechanism 700 may allow the waste management system 500 (or any of the other embodiments of the waste management system described above) to be tilted to help remove the waste from the waste management system 500. The tilt mechanism 700 may keep the waste management system 500 from tilting beyond a predetermined angle. In one embodiment, the waste management system 500 may include a pair of wheels 600 and a tilt mechanism 700 to help facilitate removal of waste from the waste management system 500. The wheels 600 may help facilitate tilting of the waste management system 500 while the tilt mechanism 700 prevents the waste management system 500 from tilting beyond the predetermined angle. The tilt mechanism 700 may be attached to any suitable area of any of the disclosed systems, including the exterior side or outwardly facing side of the rear panel, the side panel, the bottom panel, or the like. The tilt mechanism may also be included within the cabinet or holder of the system, or within one of the disclosed receivers, including also on the front panel or cabinet face.

In an embodiment, the exterior shape of the body in any of the foregoing described embodiments may be square, round, ovular, asymmetrical, and the like. The exterior panels may include any number of slots, apertures, or design, or may be solid. As shown in the figures the panels may include large square or rectangular slots that extend across much of the face of the exterior panels. Such slots may make the waste management system 200 lighter, and may make the waste management system 200 more cost effective to produce. The attachments and connections between panels may be carried out by one or more fasteners, latches, snaps, protrusions and recesses, projections and apertures, tab and aperture, mating bayonet parts, slot and tab, multiple slots and tabs, any female to male or male to female engagement, adhesives, and the like. The attachments and connections between panels may be friction fit, snap fit, pressure fit, or secured by mechanism attachment like a screw or adhesive. In an embodiment, attachments and connections between panels may be carried out by one or more screws or nails inserted through the side panels. In an embodiment, attachments and connections between panels may be carried out by dovetail joints.

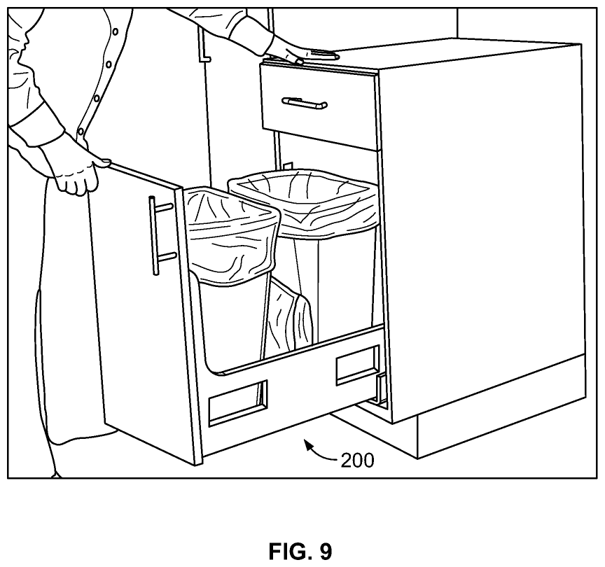

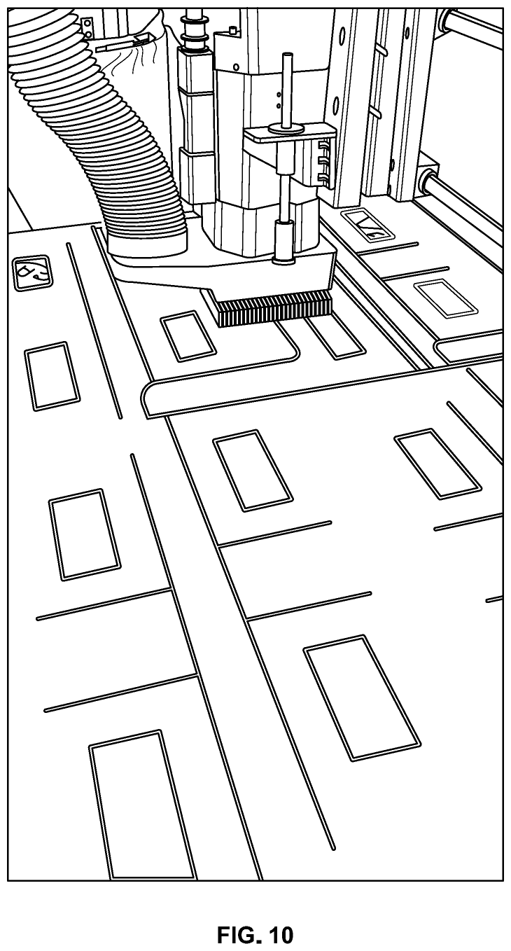

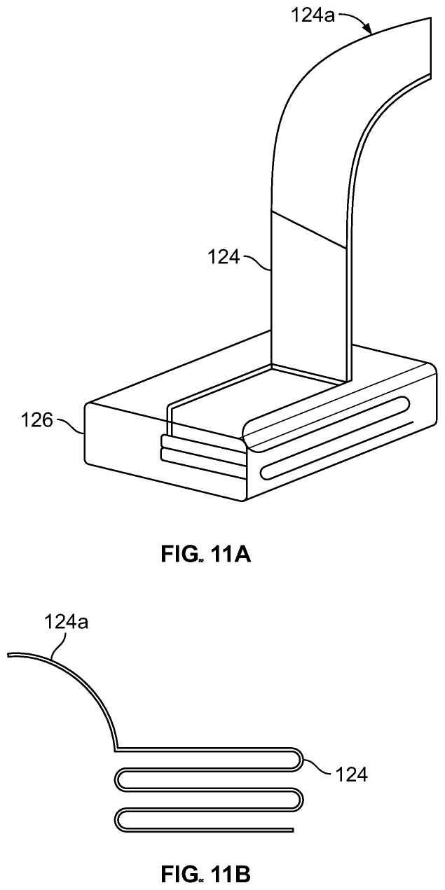

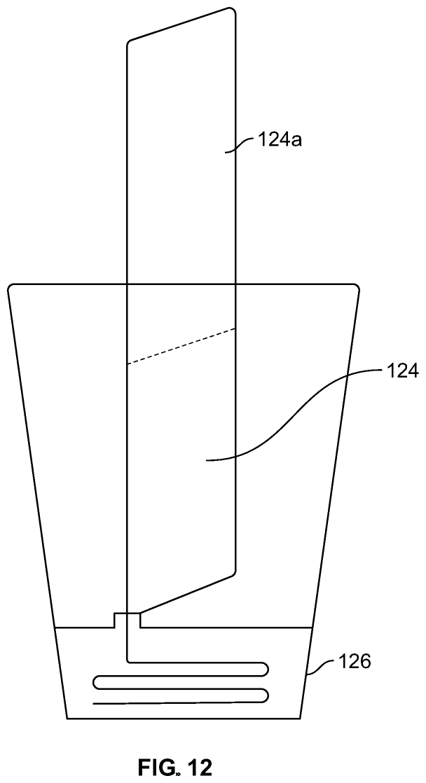

FIG. 10 shows an example of a process that may be used to form any of the front, rear, side, or middle panels as described herein. The process may use any machine, or any other method, that may be used to create, form, or manufacture a design, e.g. panels, slots, cuts, shapes, components, openings, and the like, in a sheet of material. For example, the process may include one or more of hard drives, programs, AutoCAD or CNC (computer numerical control), directives, measurements, calculations, instructions, formulas or other configurations required to enable the use of any machine, tools, printers, person, parts, or other, for the purpose of manufacturing and/or creating the system of component thereof. The process may use one or more material removal techniques such as CNC with diamond tooling, electrical discharge or spark machining, laser, water-jet, sand blasting, sawing, grinding, and the like, depending on the material. The process may also include injection molding. During injection molding, the panels may be formed with the cut-outs, holes or apertures in the panels without requiring a separate removal step. In an embodiment, the panels, and any slots and openings of the panels, may be cut out from a sheet of material using a laser printer.

In an embodiment, the panels may be formed from PVC plastic, wood, medium density fiberboard, particle board, or other composite, or any other suitable material. For example, other suitable materials may include one or more of plastic, glass, wood, metal, a composite thereof, and the like.

In an embodiment, bags or liners 122, 124 may be provided in a package 126. The package 126 may include a sequential plurality of bags 124, each bag 124 being linked to the next bag 124 in the sequence, and whereby a first bag 124a in the sequence extends at least partially through the opening 138 to ready the container assembly 100 for use. Although sequentially linked bags 124 are discussed, the container assembly 100 will also work with conventional bags that are not sequentially linked to one another.

The sequentially linked bags 124 of the package 126 are arranged in a zig-zag or fan-fold pattern as shown in FIGS. 13A, 13B and 14 whereby each individual bag 124 is attached to the next via a perforation tear line 142. The sequentially linked bags 124 may be a stack of bags 124 folded to at least partially overlap each other one to the next so that pulling one bag lifts the next bag in sequence. This particular embodiment resembles a stack of tissues contained in a dispensing box having a dispensing slot. The bags 124 may be made of any appropriate material, including, but not limited, to biodegradable or non-biodegradable materials, including but not limited to, plastic, paper, or fabric.

A plurality of bags 124 can be folded, stacked, and/or rolled into a package 126. The plurality of bags 124 can be detached from each other, or the plurality bags 124 can be connected in series and torn apart (e.g., along a perforation line between each of bag liners). The package 126 may include an opening through which a single bag 124 can be pulled. The opening of the package 126 can be generally shaped, sized, and positioned such that the opening generally aligns with the slot or opening of the middle panels. Each of the bags 124 can include a tabbed portion to facilitate removal of each bag 124 from the package 126. In an embodiment, the last bag of the package can include an indicator to signal that the package of bags should be replaced. For example, the last bag can be colored, include a message, or otherwise indicate that the package should be replaced.

In some methods of providing bags, a supplier may provide a package of multiple bags to a user of a container assembly, along with instructions to the user to insert the package of multiple bag liners into basketless system such that an opening in the package can be oriented to generally align with the bag-access opening in the middle panel to facilitate access to the bags within the package from inside of the container assembly.

The result is a package 126 of fan folded bags 124 for use in the waste management systems disclosed here. The bag 124 may be extended through a slot of the middle panel into the interior of the bucket or basketless system when one bag 124 is pulled through the slot. The sequential plurality of bags 124 may be a stack of bags fan folded to at least partially overlap each other one to the next so that pulling one bag lifts the next bag in sequence. This particular embodiment resembles a stack of tissues contained in a dispensing box having a dispensing slot and allows a user continually, easy access to one bag at a time as needed. Access to the liner packets permits periodic replacement of the package 126 of sequential fan folded bags 124, and allows a first bag in the sequence to once again be pulled through the slot of the middle panels.

In an embodiment, the bucket or basketless system may include a container partition that generally horizontally divides the bucket or basketless system into an upper waste portion and a lower weight sensor portion and include, optionally, a weight sensor. In an example, the weight sensor may be suitable for commercial use applications. In an embodiment, the partition may be a panel joined at its perimeter to an internal surface of one or more of the panels. In an embodiment, the partition may include intersecting sets of supports, such as wires.

As the bag in the waste chamber (e.g. bucket or basketless system) collects waste, the bag increases in weight and volume. When the bag reaches a predetermined weight, the sensor located below the waste chamber will emit a signal notifying the user that the liner is full and should be replaced. Preferably, the sensor will emit an RF signal to a receiver located near the top of the waste container having one or more light emitting diodes (LEDs) or other signal device. The one or more LEDs may change color based on the signal received from the weight sensor thus notifying the user that the bag should be removed and replaced. The sensor may emit a near field communication and/or Bluetooth signal to a user indicator device, such as the LEDs described. Moreover, the user indicator can also include a program or app on a smart device (such as a smart phone or tablet), computer, laptop or any other smart device. In such embodiments, the sensor can send a signal to the app or program and notify the user that the bucket/bag is full, no bag is in the bin, that the liners/bags are running low or out or that the system is in an operative condition, i.e., the bag is in place in the bucket, the bag is not full and/or that liners/bags are available in the body 505.

When a filled bag is removed from the bucket or basketless system, an integrated closure cinch tab, tie, clinch or other closure tab can be seen along the upper perimeter of the bag. The integrated closure cinch tab, tie, clinch or other closure tab can be a bendable wire or a tape-like adhesive that permits the user to tighten the closure cinch tab, tie, clinch or other closure tab around the open upper edge of the liner for proper disposal.

In an embodiment of the present technology, a motion-activated trigger causes a spray or mist to discharge into the waste chamber from a spray container. The spray or mist can be scented or unscented, and can also have antiseptic qualities such as a germ or bacteria killing agent. A movement sensor, preferably located on the edge of the liner passing port, records the movement of the liner when the liner is being replaced. In an embodiment, the container includes a spray canister. The spray canister releases the spray or mist into the waste chamber after receiving a signal from the movement sensor.

Although the embodiments of the present teachings have been illustrated in the accompanying drawings and described in the foregoing detailed description, it is to be understood that the present teachings are not to be limited to just the embodiments disclosed, but that the present teachings described herein are capable of numerous rearrangements, modifications and substitutions without departing from the scope of the claims hereafter. The claims as follows are intended to include all modifications and alterations insofar as they come within the scope of the claims or the equivalent thereof.

What is claimed is:

1. A bucketless waste container and liner system, comprising:
a front panel, a rear panel, and two side panels, the two side panels connecting the front panel and the back panel, and the front, rear, and side panels forming a housing;
at least one middle panel positioned within the housing and defining a first chamber configured to receive and hold a liner and a second chamber configured to receive a liner packet;
wherein the middle panel includes a feed slot that is configured to allow the feeding of a liner into the first chamber from a liner packet in the second chamber.

2. The bucketless waste container and liner system of claim 1, wherein the system does not include a removable waste bucket.

3. The bucketless waste container and liner system of claim 1, wherein the liner when positioned in the first chamber is configured to receive waste.

4. The bucketless waste container and liner system of claim 1, wherein at least one of the front, rear, or side panels includes at least one cut-out.

5. The bucketless waste container and liner system of claim 4, wherein the at least one cut-out is formed by computer numerical control with diamond tooling, electrical discharge or spark machining, laser, water jet, sand blasting, sawing, or grinding.

6. The bucketless waste container and liner system of claim 1, wherein the liner packet includes a plurality of liners and the liners are fed sequentially from the liner packet in the second chamber, through the feed slot, and into the first chamber when the used liner in the first chamber is removed.

7. The bucketless waste container and liner system of claim 6, wherein the liners are fed and replaced automatically from the liner packet in the second chamber, through the feed slot, and into the first chamber when the used liner in the first chamber is removed.

8. The bucketless waste container and liner system of claim 1 further including a rail and pull out track system.

9. The bucketless waste container and liner system of claim 8, wherein the system is configured to be put into a cabinet and the rail and pull out track system facilitate the selective access to and closure of the system into the cabinet.

10. The bucketless waste container and liner system of claim 1, wherein a portion of the side panels that defines the first chamber are a first height and a portion of the side panels that defines the second chamber are a second height.

11. The bucketless waste container and liner system of claim 10, wherein the second height of the side panels defining the second chamber is smaller than the first height of the side panels defining the first chamber.

12. The bucketless waste container and liner system of claim 1 further including a second middle panel, wherein the second middle panel defines a third chamber, wherein the third chamber is configured to receive and hold a liner, and wherein the second middle panel includes a feed slot that is configured to allow the feeding of a liner from a second liner packet into the third chamber from the second liner packet in the second chamber.

13. The bucketless waste container and liner system of claim 12, a portion of the side panels that defines the first and third chamber are a first height and a portion of the side panels that defines the second chamber are a second height, wherein the second height is smaller than the first height.

14. An integrated waste container and liner system, comprising:
a first chamber configured to receive a liner,
a second chamber configured to receive a liner packet,
wherein the first chamber and second chamber are adjacent and separated by a middle panel, the middle panel comprising feed slot that is configured to allow the feeding of a liner into the first chamber from a liner packet in the second chamber.

15. The integrated waste container and liner system of claim 14, wherein the first chamber is a first height and the second chamber is a second height, wherein the second height is smaller than the first height.

16. The integrated waste container and liner system of claim 14, further including a third chamber configured to receive a liner, wherein the second chamber and third chamber are adjacent and separated by a second middle panel, the second middle panel comprising feed slot that is configured to allow the feeding of the liner into the third chamber from a second liner packet in the second chamber.

17. The integrated waste container and liner system of claim 16, wherein the third chamber and first chamber are a first height and the second chamber is a second height, wherein the second height is smaller than the first height.

18. The integrated waste container and liner system of claim 14, wherein the system does not include a removable waste bucket.

19. The integrated waste container and liner system of claim 14, wherein the chambers include a plurality of cut-outs.

20. The integrated waste container and liner system of claim 14, wherein the liners are fed sequentially and automatically from the liner packet in the second chamber, through the feed slot, and into the first chamber when the used liner in the first chamber is removed.
